(19) United States
(12) Patent Application Publication
(10) Pub. No.: US 2012/0150581 A1
(43) Pub. Date: Jun. 14, 2012

(54) AUTOMATED ANALYSIS AND MECHANIZATION OF SCHEDULING

(75) Inventor: Lon Daniel McPhail, San Diego, CA (US)

(73) Assignee: KUITY Corp., San Diego, CA (US)

(21) Appl. No.: 13/267,841

(22) Filed: Oct. 6, 2011

Related U.S. Application Data
(60) Provisional application No. 61/390,520, filed on Oct. 6, 2010.

(51) Int. Cl. G06Q 10/10

(52) U.S. Cl. 705/7.19

(57) ABSTRACT

Systems and methods for cross-domain calendaring are described. A plurality of invitees is identified in response to an event scheduling request and scheduling information for each invitee is obtained. The scheduling information includes information obtained from at least two different types of calendaring system and comprises information regarding other events associated with each invitee. A priority is set for each invitee based on the scheduling information and the event scheduling request.

### CROSS-REFERENCE TO RELATED APPLICATIONS

The present application claims priority from U.S. Provisional Patent Application No. 61/390,520 filed Oct. 6, 2010, which is expressly incorporated by reference herein.

### BACKGROUND OF THE INVENTION

### Field of the Invention

The present invention relates generally to scheduling and more particularly to tools that automatically determine common availability across multiple domains and Calendar system types.

### BRIEF SUMMARY OF THE INVENTION

Certain embodiments of the invention provide cross-domain and cross-application scheduling tools which enable a user to automatically determine the common availability of multiple persons and/or resources across multiple domains, to determine the first available time for all attendees to meet regardless of location or telecom conditions, and to be able to automatically suggest the next available time should any invited party declare an unavailability.

Certain embodiments of the invention provide systems, methods, processes, and tools for determining the cross-domain and cross-application scheduling availability. Discrete, strategic capabilities enabled according to certain aspects of the invention may include an ability to identify all meeting invitees, an ability to identify all schedule availabilities for each invitee, an ability to identify the nature of all scheduled events of each invitee, the ability to differentiate between teleconferences and in-person meetings, and to determine the physical location of all in-person scheduled events. Discrete, strategic capabilities enabled according to certain aspects of the invention may also include an ability to identify the relative importance and/or priority of each scheduled event of each invitee, and to determine the relative priority between existing scheduled events and the event under analysis to be scheduled. Discrete, strategic capabilities enabled according to certain aspects of the invention may also include an ability to identify and record the nature, desired length, desired location, desired priority, desired participants, and desired relative date range of the to-be-scheduled meeting. Discrete, strategic capabilities enabled according to certain aspects of the invention may also include an ability to analyze all facets of each invitee's schedule to determine actual effective availability, including factors such as travel time required to reach the requested schedule event and the travel time required from the to-be-scheduled event to the next scheduled event.

In certain embodiments, the discrete, strategic capabilities enabled according to certain aspects of the invention may include an ability to analyze various determinations and findings enabled by aspects of the invention to determine the best possible match or matches for the to-be-scheduled meeting against the availability of the invitees and/or to make the best recommendations for invitee schedule changes in the event no common availability exists across one or more invitees' availability within the requested parameters provided by the meeting organizer. Discrete, strategic capabilities enabled according to certain aspects of the invention may also include an ability to reserve and/or “hold as tentative” earliest commonly available schedule time on each invitees' schedule for the to-be-scheduled event until each invitee declares the meeting time acceptable or unacceptable.

Certain embodiments determine availability and related attributes of scheduled events of each attendee via a sub-function attached to each invitee's scheduling data, and can then determine the best available time for the to-be-scheduled event.

### BRIEF DESCRIPTION OF THE DRAWINGS

FIG. 1 is simplified depiction of one embodiment of the present invention.

FIG. 2 is a simplified block schematic depicting a centralized scheduling system according to certain aspects of the invention.

FIG. 3 is simplified process functional block diagram according to certain aspects of the invention.

FIG. xx is a simplified block schematic illustrating a processing system employed in certain embodiments of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the descriptions herein are intended to encompass other embodiments including a plurality of the same component, and vice-versa, unless explicitly stated otherwise. Moreover, applicants do not intend for any term in the specification or claims to be ascribed an uncommon or special meaning unless explicitly set forth as such. Further, embodiments of the present invention encompass present and future known equivalents to the components referred to herein by way of illustration.

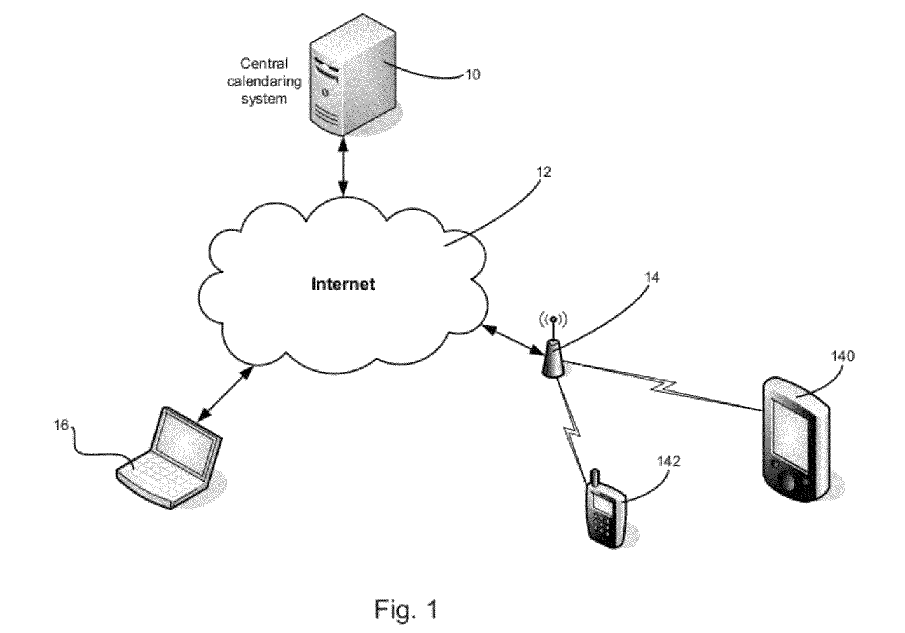

Certain embodiments of the invention provide a centralized calendaring system that performs a variety of automated analysis and mechanization processes deployed as a universal scheduling system that can operate across network domains and between a variety of calendaring systems found on those network domains. In one example, a central calendaring system may be employed to facilitate scheduling of events for a plurality of users of different calendar and/or Email systems. In certain embodiments, resources such as meeting rooms, satellite availability, teleconferencing facilities, projectors, support staff, etc. can also be scheduled, including when the resources are tracked using a calendaring system. For ease of description, resources will be considered a user that can be schedules and prioritized. In the simple example depicted in FIG. 1, central calendaring system 10 communicates with multiple devices 140, 142 and 16, that are typically connected to different network domains and that can operate in different calendar domains. For example, computing device 16 may be located on a business network and, where the device is notebook or other portable computing device, may connect from a user's home, or from any location that can provide wireless or other network connection. Moreover, computing device 16 may employ one or more calendaring systems. For example, the user may conduct business using an enterprise system, and may use a personal Email account or social networking application for non-business use. In one example, the enterprise system may be implemented using Microsoft Outlook, while the personal system may be accessed through Google Calendar. It will appreciated that the selection of a system for enterprise and personal use is entirely a matter of user choice and it is contemplated that any suitable calendaring system can be accommodated by a central calendaring system constructed according to certain aspects of the invention.

Continuing with FIG. 1, certain devices, including personal communication device 142 and tablet computer 140, which connect through wireless network transceiver 14, may have internal calendars that can interact with a central calendaring system 10 according to certain aspects of the invention. Personal communication device 142 can be a cellular telephone, a smart phone, a multimedia player, a gaming device or any other potable device configurable to communicate wirelessly with a network. In addition to personal communication device 142 and tablet computer 140, other computing devices that may be connected using wired or wireless networks can be supported in certain embodiments of the invention.

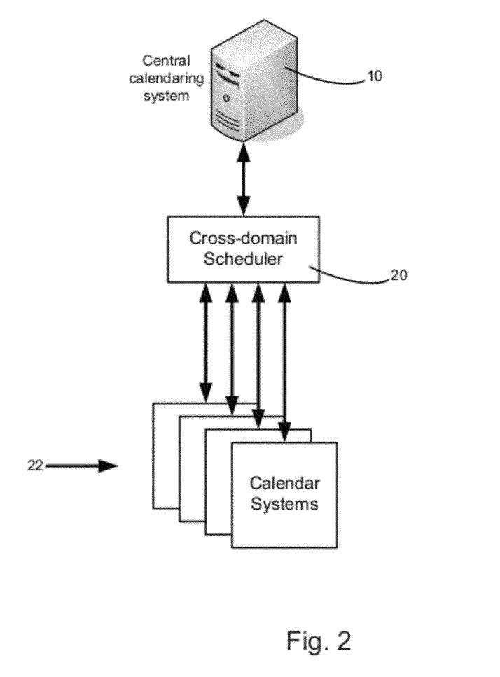

Certain embodiments of the invention may be used to coordinate, organize and manage calendared events across multiple calendaring domains, independently of the physical network domain upon which user devices are located. With reference to FIG. 2, central calendaring system 10 may be configured to perform any of a plurality of functions, including maintaining a central calendar for identified users and/or scheduled events; and creating and coordinating events by interrogating and negotiating with two or more different calendar systems 22, which can be implemented using the same or different calendaring systems. Central calendaring system 10 may employ a customized, adapted or configured universal scheduler 20 that communicates with each of the calendar systems 22 to determine availability of proposed participants of an event and to request reservation of time for the event and/or to request notification of the user that the event has been calendared. Scheduler 20 may be embodied in the same physical computing device as central calendaring system 10 and/or may be implemented in a plurality of different computing systems that can be physically remote from one another. In certain embodiments, central calendaring system 10 may be configured to provide notification directly to participants and to directly receive response confirming or declining the event. Typically, central calendaring system 10 can be configured to update each of calendar systems 22 (using scheduler 20, for example) when a communication is received from a user in relation to the calendared event.

In certain embodiments, central calendaring system 10 can be adapted and/or configured to monitor, track, and analyze historical scheduling trends for individual users, groups of users and resources. Information obtained from such monitoring, tracking and analysis may be used to predict the viability of a given timeslot. In one example, central calendaring system 10 monitors, tracks, and analyzes historical scheduling trends associated with each user of the system and/or for each participant in a selected event or event type. Central calendaring system 10 can predict the viability of a given timeslot regardless of the availability at the time of scheduling consideration.

In one example, certain timeslots may be reserved for another event of a type that has a high percentage of cancellations. In another example, central calendaring system 10 can use historical data associated with an individual participant, and trends derived from such data, to project the probability that the participant will actually be able to attend a desired meeting at the actual time of the meeting, although the participant may have other commitments at the time the event is calendared. Therefore, certain aspects of the invention can account for volatile calendars associated with users and resources. According to certain aspects of the invention, events can be scheduled even when one or more proposed participants have not reported availability, but where historical information is available to enable reliable estimates of probability of availability of the non-reporting participants.

In certain embodiments, scheduler 20 can act as a proxy for a user of calendar systems 22; in certain embodiments account access information related to users can be maintained on scheduler 20 but cannot be viewed or accessed directly by central calendaring system 10. In certain embodiments scheduler 20 can be defined as a delegate for the user and typically is granted limited permission to view, create, modify or delete certain calendar events. Accordingly, the central calendaring system 10 and/or scheduler 20 can be configured to maintain account access information or the individual calendar systems can be configured to permit certain accesses by scheduler 20, thereby allowing a wide range of security options to protect calendar information. Additionally, scheduler 20 may mirror information provided by calendar systems 22 in response to individual requests for information. For example, scheduler 20 may request availability information for a user over a given time frame and this information may be maintained until a calendared event is agreed and confirmed. In certain embodiments, scheduler 20 may provisionally reserve certain time periods in order to find a commonly acceptable date and time for an event.

In certain embodiments, calendaring system 10 can automatically create an event calendar by personal network, region, topic, etc. enabling meeting planners (event, seminar, conference, wedding etc.) to discern the best time to hold an event that doesn't conflict with other key events. Certain aspects of the invention can optimize meetings for people traveling to a region. For example, the system may be configured to analyze contacts, relationship management system, Facebook, LinkedIn and other components that manage relationships to identify potential contacts that the traveler can meet while in the area. For example, analytics systems can be configured to determine how a maximum number of people in a region can be contacted and/or visited and the scheduling system can arrange and optimized business and/or personal trips to achieve optimal connections according to user preferences and system rules.

In certain embodiments, the system can reach into social networking sites such as LinkedIn, Facebook, etc. in order to perform analytics that deliver a world class social secretary in virtual form.

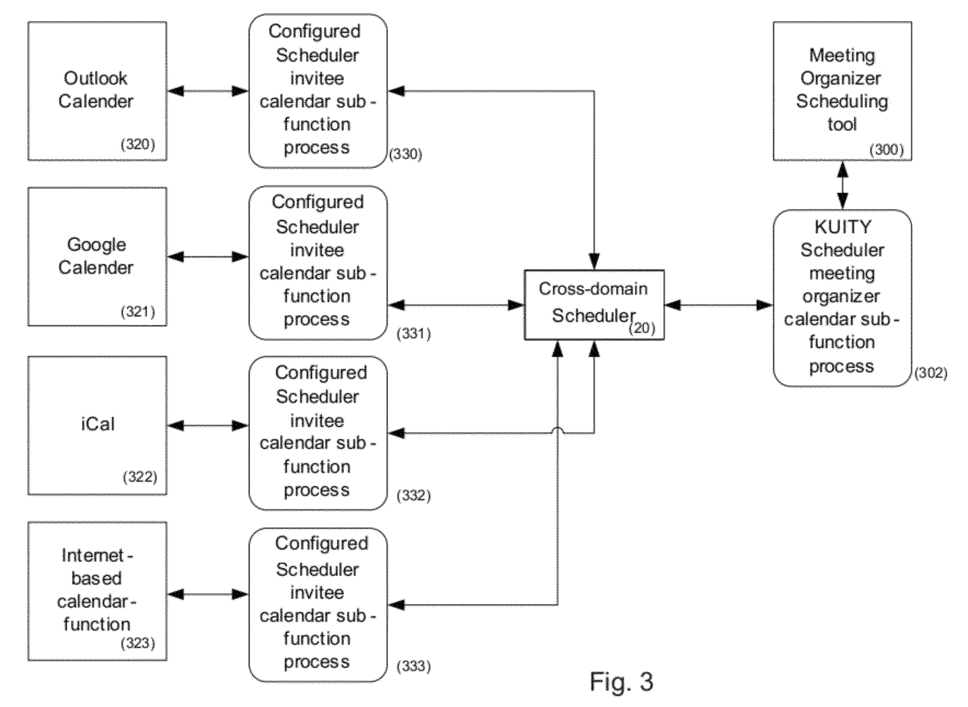

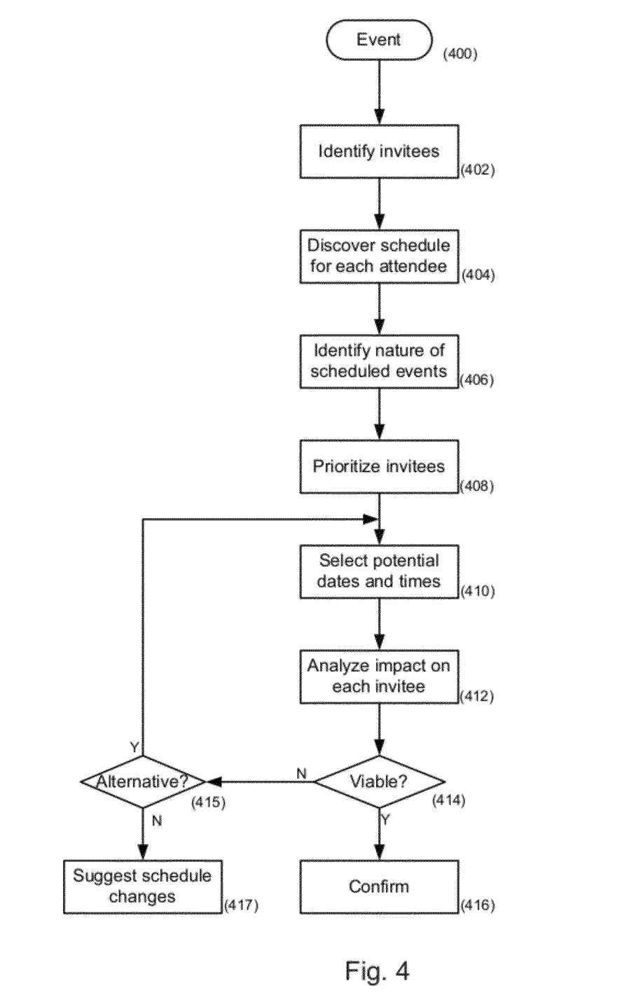

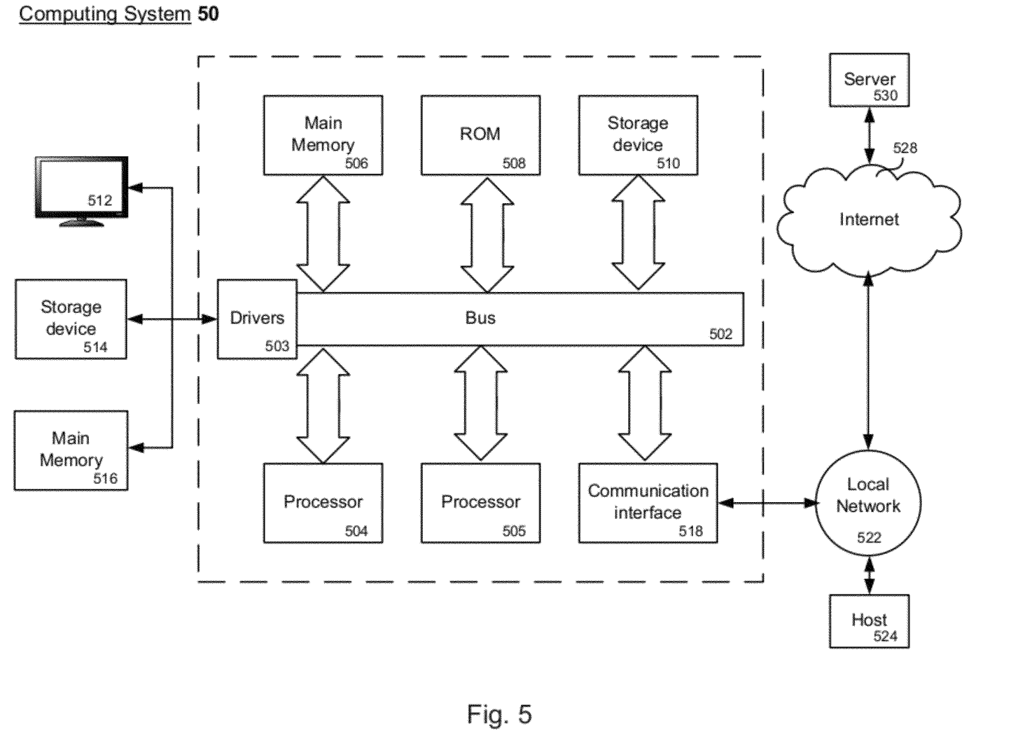

FIG. 3 depicts certain functional components of a system constructed according to certain aspects of the invention. Scheduler 20 can function as conduit for scheduling activity between a scheduling engine 302 that is responsive to meeting organizer scheduling tool 300. A plurality of systems and applications can interact with scheduling engine 302. For example, one or more customized scheduling tools 300 can be deployed to implement scheduling rules for an enterprise or group of users. One or more social networking systems can interact with scheduling engine 302 and one or more analytics systems can receive scheduling information in order to facilitate improved and optimized scheduling functions within an enterprise.

In certain embodiments, scheduling engine 20 can be configured to maintain historical data for one or more or all individual users and can typically be adapted to aggregate historical data for groups of users and/or for frequently occurring events and event types, Information that may be captured can include invitation acceptance rates, which may be categorized by time-of-day, by weekday, by month, etc. Information that may be captured can include cancellations after acceptance and actual attendance at events. Historical data captured, maintained and aggregated by scheduling engine can further include geographical location of individual users. The historical information maybe used to correlate acceptance rates with time and date of meetings and/or location of invitees and/or meeting place. In this regard, method of participation is typically captured and can indicate preferences for in-person attendance or attendance by teleconference.

For each calendar system 320-323 registered or incorporated in the universal scheduling system, an agent 330-333 may be deployed in the calendar system 320-323. The agent may include software plug-ins, libraries, scripts, macros or any component that can be integrated with the calendar system 320-323. Agents 330-333 typically perform various functions that enable certain aspects of the invention. For example, agents 330-333 may intercept Email or SMS messages received from universal scheduler 20 and may perform queries, issue invitations, provide status information and/or reserve calendar dates on the host Email system 320-323. Accordingly, users of the system may be shielded from communications related to negotiation of an event date or format. For example, a user may respond to an invitation by indicating preferred dates which are often prioritized. Thereafter, the user receives only Emails or SMS messages that confirm a date, time and location of the event or that request an alternative date or time. In another example, some portion of the scheduling process may be performed without user notification and in order to identify high-potential candidates for meeting dates.

Agents 330-333 may also communicate updates between scheduler 20 and calendar systems 320-323. Updates may include updates sent by scheduler 20 indicating changes in status, reminders, logistics, travel directions, and so on. Updates may include updates and/or snapshots of user calendars sent by agents 330-333 periodically, in response to a “heartbeat request” or upon change in calendar events detected by agents 330-333. Agents 330-333 may also harvest information related to users, including current and planned geographic location and information related to calendar systems 320-323. Agents 330-333 may also detect changes in invitee schedules and can automatically initiate rescheduling to accommodate the detected changes.

Agents 330-333 and scheduler 20 typically communicate using a proprietary protocol that may use any available data transport mechanism, including SMS and Email. The proprietary protocol can enable transparent operation of the universal scheduling system. In certain embodiments, calendaring requests between users of a common calendar system 320-323 or type of calendar system 320-323 may use “native” protocols for communicating calendaring requests, although Agents 330-333 and scheduler 20 typically monitor such native communications and may augment or modify requests consistent with the operation of the universal calendaring system.

FIG. 4 depicts an example in a generalized block diagram illustrating certain functional elements of one embodiment of the present invention. In certain embodiments, availability and related attributes of scheduled events are determined for each invitee—upon acceptance, each attendee—using a scheduler 330-333 configured to be attached to and/or communicate with each invitee's scheduling data 320-323. Upon retrieving sufficient information, from or through schedulers 330-323, scheduler 20 can then determine the best available time for the to-be-scheduled event.

Certain embodiments provide systems and methods that reflect an execution methodology described herein. The description provided includes a serialized work-flow description of the methodology scheduled for an application according to certain aspects of the invention.

Referring also to FIG. 4, a simplified example of a scheduling process is described that identifies certain functions, actions and decisions that obtain insights into one or more enterprises. The process commences at step 400, when a request for an event is received. The request may be generated by a user on any calendar system and/or through a dedicated request entry system, which be embodied in a web page or web application. The request may be automatically generated by rule in a calendaring system, a project management system, a social networking environment, a multi-user gaining system, an augmented reality environment, through advertising or any other system that can, for example, initiate or coordinate user activities.

At step 402, all meeting invitees are identified. Invitees may be identified directly in the request or can be identified according to predefined rule. For example, rules controlling to whom invitations are made may include rules specifying group membership, demographics, seniority in an organization, prior attendance, concurrency of subscription and so on. At step 404, the schedule availabilities for each invitee are identified. Scheduler 20 may be dispatched or configured to obtain and/or maintain schedule availability. At step 406, the nature of events scheduled for each invitee may be determined. The nature of scheduled events of each invitee may indicate whether previously scheduled events require in-person attendance, travel and whether attendance is feasible using teleconferencing, including videoconferencing, conference call, or using virtual world (online) systems, etc. Typically, information may be obtained that identifies the likely geographical locations of the invitee before and after the scheduled event in order to ascertain whether travel may be required and the nature of the travel (cost, distance, time, availability of flights, etc.).

At step 408, the relative importance/priority of each scheduled event and for each invitee can be determined. Certain invitees may need to be physically present at an event location and different attendees may need to be at different locations for the event. Similarly, the event may have varying significances for different invitees and scheduler 20 may evaluate the relative priorities between existing scheduled events for one or more users. Subsequent analysis may determine that certain invitees could or should be dropped from the invitation list in order to allow selection of a date and time that satisfies the scheduling needs of higher priority invitees.

At step 410, the nature of the event, including desired length of time required, desired location, desired priority and desired participants can be evaluated to obtain possible dates and times that fall within a requested or desired date range of the to-be-scheduled meeting. Typically, a number of potential dates and times and invitee lists can be generated as prospective event dates. At step 412, various facets of each invitee's schedule can be analyzed for one or more prospective event dates to determine actual effective availability including such factors as costs and travel time required to reach the requested schedule event and travel time required from the to-be-scheduled event to the next scheduled event. Prospective event dates can be prioritized as these effective availabilities are determined. In one example, prioritization may be based on earliest available date. In another example, prioritization can be based on least cost to arrange attendance. In many embodiments, prioritization factors and parameters can be configured as desired to obtain, for example, least cost earliest available date in which certain invitees can be present at a specific geographic location.

Step 414 typically includes analyzing one or more preferred (i.e. prioritized) prospective event dates to determine the best possible match or matches for each invitee based on the availability of the invitees. If, at step 414, one or more prospective event dates are considered viable, invitations can be sent at step 416 and, subject to intended attendance by key invitees, the event can be confirmed. Confirmation at step 416 may include reserving or holding tentative earliest commonly available schedule time on each invitee's schedule for the to-be-scheduled event until each invitee declares the meeting time acceptable or unacceptable. If, at step 414, no prospective event date is considered viable, a reprioritization of certain invitees' attendance and reprioritization of certain invitees other events can be attempted at step 415 and, if successful, new prospective event dates can be selected at step 410; if unsuccessful, then alternative dates and/or durations, typically outside of the requested parameters for the event, can be suggested at step 417. At step 417, modifications to the invitee list and/or event location may also be suggested. Additionally, a detailed analysis of the findings of the process may be generated as recommendations for invitee schedule changes in the event no common availability is found for all invitees within the requested parameters that were provided by the meeting organizer.

The methodologies, tools and processes for the automated analysis and mechanization of cross-domain scheduling identifies and reserves desired schedule slots, accepts and adapts to invitee-declared desires, and enables meeting organizers to commit meetings to invitee schedules in fractions of time and efforts currently expended.

Certain embodiments of the invention provide cross-domain scheduling tools which enable a user to automatically determine the common availability of multiple persons and/or resources across multiple domains, to determine the first available time for all attendees to meet regardless of location or telecom conditions, and to be able to automatically suggest the next available time should any invited party declare an unavailability.

Certain embodiments of the invention provide systems, methods, processes, and tools for determining the cross-domain scheduling availability. Discrete, strategic capabilities enabled according to certain aspects of the invention may include an ability to identify all meeting invitees, an ability to identify all schedule availabilities for each invitee, an ability to identify the nature of all scheduled events of each invitee, the ability to differentiate between teleconferences and in-person meetings, and to determine the physical location of all in-person scheduled events. Discrete, strategic capabilities enabled according to certain aspects of the invention may also include an ability to identify the relative importance and/or priority of each scheduled event of each invitee, and to determine the relative priority between existing scheduled events and the event under analysis to be scheduled. Discrete, strategic capabilities enabled according to certain aspects of the invention may also include an ability to identify and record the nature, desired length, desired location, desired priority, desired participants, and desired relative date range of the to-be-scheduled meeting. Discrete, strategic capabilities enabled according to certain aspects of the invention may also include an ability to analyze all facets of each invitee's schedule to determine actual effective availability, including factors such as travel time required to reach the requested schedule event and the travel time required from the to-be-scheduled event to the next scheduled event.

In certain embodiments, the discrete, strategic capabilities enabled according to certain aspects of the invention may include an ability to analyze various determinations and findings enabled by aspects of the invention to determine the best possible match or matches for the to-be-scheduled meeting against the availability of the invitees and/or to make the best recommendations for invitee schedule changes in the event no common availability exists across one or more invitees' availability within the requested parameters provided by the meeting organizer. Discrete, strategic capabilities enabled according to certain aspects of the invention may also include an ability to reserve and/or “hold as tentative” earnest commonly available schedule time on each invitees' schedule for the to-be-scheduled event until each invitee declares the meeting time acceptable or unacceptable.

### System Description

Turning now to FIG. 5, certain embodiments of the invention employ a processing system that includes at least one computing system 500 deployed to perform certain of the steps described above. Computing systems may be a commercially available system that executes commercially available operating systems such as Microsoft Windows®, MacOS, UNIX or a variant thereof, Linux, a real time operating system and or a proprietary operating system. The architecture of the computing system may be adapted, configured and/or designed for integration in the processing system, for embedding in one or more of an image capture system, a manufacturing/machining system, a graphics processing workstation, specialized server 10, scheduler 20, and/or a mobile computing device 140 or 142. In one example, computing system 500 comprises a bus 502 and/or other mechanisms for communicating between processors, whether those processors are integral to the computing system 50 (e.g. 504, 505) or located in different, perhaps physically separated computing systems 500. Device drivers 503 may provide output signals used to control internal and external components

Computing system 500 also typically comprises memory 506 that may include one or more of random access memory (“RAM”), static memory, cache, flash memory and any other suitable type of storage device that can be coupled to bus 502. Memory 506 can be used for storing instructions and data that can cause one or more of processors 504 and 505 to perform a desired process. Main memory 506 may be used for storing transient and/or temporary data such as variables and intermediate information generated and/or used during execution of the instructions by processor 504 or 505. Computing system 500 also typically comprises non-volatile storage such as read only memory (“ROM”) 508, flash memory, memory cards or the like; non-volatile storage may be connected to the bus 502, but may equally be connected using a high-speed universal serial bus (USB), Firewire or other such bus that is coupled to bus 502. Non-volatile storage can be used for storing configuration, and other information, including instructions executed by processors 504 and/or 505. Non-volatile storage may also include mass storage device 510, such as a magnetic disk, optical disk, flash disk that may be directly or indirectly coupled to bus 502 and used for storing instructions to be executed by processors 504 and/or 505, as well as other information.

Computing system 500 may provide an output for a display system 512, such as an LCD flat panel display, including touch panel displays, electroluminescent display, plasma display, cathode ray tube or other display device that can be configured and adapted to receive and display information to a user of computing system 500. Typically, device drivers 503 can include a display driver, graphics adapter and/or other modules that maintain a digital representation of a display and convert the digital representation to a signal for driving a display system 512. Display system 512 may also include logic and software to generate a display from a signal provided by system 500. In that regard, display 512 may be provided as a remote terminal or in a session on a different computing system 500. An input device 514 is generally provided locally or through a remote system and typically provides for alphanumeric input as well as cursor control 516 input, such as a mouse, a trackball, etc. It will be appreciated that input and output can be provided to a wireless device such as a PDA, a tablet computer, a smartphone or other system suitable equipped to display the images and provide user input.

According to one embodiment of the invention, portions of the process depicted in FIG. 4, may be performed by computing system 500. Processor 504 executes one or more sequences of instructions. For example, such instructions may be stored in main memory 506, having been received from a computer-readable medium such as storage device 510. Execution of the sequences of instructions contained in main memory 506 causes processor 504 to perform process steps according to certain aspects of the invention. In certain embodiments, functionality may be provided by embedded computing systems that perform specific functions wherein the embedded systems employ a customized combination of hardware and software to perform a set of predefined tasks. Thus, embodiments of the invention are not limited to any specific combination of hardware circuitry and software.

The term “computer-readable medium” is used to define any medium that can store and provide instructions and other data to processor 504 and/or 505, particularly where the instructions are to be executed by processor 504 and/or 505 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 504 and 505 or remotely, typically by use of network connection. Non-volatile storage may be removable from computing system 504, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 500. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 504 and/or 505. For example, the instructions may initially be retrieved from a magnetic disk of a remote computer and transmitted over a network or modem to computing system 500. The instructions may optionally be stored in a different storage or a different part of storage prior to or during execution.

Computing system 500 may include a communication interface 518 that provides two-way data communication over a network 520 that can include a local network 522, a wide area network or some combination of the two. For example, an integrated services digital network (ISDN) may used in combination with a local area network (LAN). In another example, a LAN may include a wireless link. Network link 520 typically provides data communication through one or more networks to other data devices. For example, network link 520 may provide a connection through local network 522 to a host computer 524 or to a wide are network such as the Internet 528. Local network 522 and Internet 528 may both use electrical, electromagnetic or optical signals that carry digital data streams.

Computing system 500 can use one or more networks to send messages and data, including program code and other information. In the Internet example, a server 530 might transmit a requested code for an application program through Internet 528 and may receive in response a downloaded application that provides for the anatomical delineation described in the examples above. The received code may be executed by processor 504 and/or 505.

### ADDITIONAL DESCRIPTIONS OF CERTAIN ASPECTS OF THE INVENTION

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide scheduling tools which enable the user to automatically determine the common availability of multiple users across multiple domains, to determine the first available time for all attendees to meet regardless of location or telecom conditions, and to be able to automatically suggest the next available time should any invited party declare an unavailability. Scheduling tools may identify the nature, desired length, desired location, desired priority, desired participants, and desired relative date range of the to-be-scheduled meeting, and may then analyze all facets of each invitee's schedule to determine actual effective availability including such factors as travel time required to the requested schedule event and travel time required from the to-be-scheduled event to the next scheduled event, then reserves the time in each schedule and recommends the solution to the meeting organizer.

Certain embodiments of the invention provide systems and methods for cross-domain calendaring. Certain embodiments comprise identifying a plurality of invitees in response to an event scheduling request. Certain embodiments comprise obtaining scheduling information each invitee. In certain embodiments, the scheduling information includes information obtained from at least two different types of calendaring system. In certain embodiments, the scheduling information includes other events associated with each invitee. Certain embodiments comprise assigning a priority for each invitee based on the scheduling information and the event scheduling request, wherein assigning priorities includes determining the level of necessity of attendance by each invitee. Certain embodiments comprise selecting a prospective event date based on the assigned priorities and the event scheduling request.

In certain embodiments, at least two of the invitees use a calendaring system in different domains. Certain embodiments comprise the different domains comprise different network domains. In certain embodiments, the different domains comprise different enterprise systems. Certain embodiments comprise identifying a resource to be used in connection with the event that is the subject of the event scheduling request the requested a plurality of invitees in response to an event scheduling request. In certain embodiments, selecting a prospective event date includes determining availability of the resource. In certain embodiments, the resource comprises a teleconferencing system. In certain embodiments, the resource comprises support personnel. In certain embodiments, the scheduling information is obtained by a cross-domain scheduler configured to interact with a plurality of different calendaring systems. In certain embodiments, the plurality of different calendaring systems comprises an enterprise calendaring system. In certain embodiments, the plurality of different calendaring systems comprises an Internet-based appointment system.

Certain embodiments of the invention provide systems comprising a server configured to maintain calendaring information related to a plurality of users and a plurality of scheduled events. Certain embodiments comprise a cross-domain scheduler coupled the server and further coupled through a network to a plurality of different calendaring systems. In certain embodiments, at least one of the plurality of users maintains a calendar on each calendaring system. In certain embodiments, the server causes the cross-domain scheduler to query a calendaring system corresponding to each of the certain users in response to a scheduling request identifying certain of the users, and to provide scheduling information related to the each user to the server. In certain embodiments, the server is configured to select a first available time for all of the certain to meet regardless of location or telecom conditions. In certain embodiments, the server is configured to automatically suggest a next available time for all of the certain to meet upon receiving a declaration of unavailability from any of the selected users.

Certain embodiments of the invention provide non-transitory computer-readable storage media encoded with data and instructions that, when executed by a computing system, cause the computing system to perform one or more steps of a process. In certain embodiments, the process comprises identifying a plurality of invitees in response to an event scheduling request. In certain embodiments, the process comprises obtaining scheduling information each invitee. In certain embodiments, the scheduling information includes information obtained from at least two different types of calendaring system. In certain embodiments, the scheduling information includes other events associated with each invitee. In certain embodiments, the process comprises assigning a priority for each invitee based on the scheduling information and the event scheduling request. In certain embodiments, assigning priorities includes determining the level of necessity of attendance by each invitee. In certain embodiments, the process comprises selecting a prospective event date based on the assigned priorities and the event scheduling request. In certain embodiments, at least two of the invitees use a calendaring system in different domains. In certain embodiments, the data and instructions, when executed by a computing system, cause the computing system to identify a resource to used in connection with the event that is the subject of the event scheduling request the requested a plurality of invitees in response to an event scheduling request. In certain embodiments, selecting a prospective event date includes determining availability of the resource.

In certain embodiments, the resource comprises a teleconferencing system. In certain embodiments, the resource comprises support personnel. In certain embodiments, the scheduling information is obtained by a cross-domain scheduler configured to interact with a plurality of different calendaring systems. In certain embodiments, the plurality of different calendaring systems comprises an enterprise calendaring system. In certain embodiments, the plurality of different calendaring systems comprises an Internet-based appointment system.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method, comprising:
identifying a plurality of invitees in response to an event scheduling request;
obtaining scheduling information each invitee, wherein the scheduling information includes information obtained from at least two different types of calendaring system, and wherein the scheduling information includes information related to other events associated with each invitee;
assigning a priority for each invitee based on the scheduling information and the event scheduling request, wherein assigning priorities includes determining the level of necessity of attendance by each invitee; and
selecting a prospective event date based on the assigned priorities and the event scheduling request.

2. The method of claim 1, wherein at least two of the invitees use a calendaring system in different domains.

3. The method of claim 2, wherein the different domains comprise different network domains.

4. The method of claim 2, wherein the different domains comprise different enterprise calendaring systems.

5. The method of claim 1, further comprising identifying a resource to used in connection with the event that is the subject of the event scheduling request the requested a plurality of invitees in response to an event scheduling request, wherein selecting a prospective event date includes determining availability of the resource.

6. The method of claim 5, wherein the resource comprises a teleconferencing system.

7. The method of claim 5, wherein the resource comprises support personnel.

8. The method of claim 1, wherein the scheduling information is obtained by a universal scheduler configured to interact with a plurality of different calendaring systems.

9. The method of claim 8, wherein the plurality of different calendaring systems comprises an enterprise calendaring system.

10. The method of claim 8, wherein the plurality of different calendaring systems comprises an Internet-based appointment system.

11. A system comprising:
a server configured to maintain calendaring information related to a plurality of users and a plurality of scheduled events;
a universal scheduler coupled the server and further coupled through a network to a plurality of different calendaring systems, wherein for each calendaring system, at least one of the plurality of users maintains a calendar on the each calendaring system,
wherein responsive to a scheduling request identifying certain of the users, the server causes the universal scheduler to query a calendaring system corresponding to each of the certain users and to provide scheduling information related to the each user to the server, and
wherein the server is configured to select a first available time for all of the certain to meet regardless of location or telecom conditions.

12. The system of claim 11, wherein the server is configured to automatically suggest a next available time for all of the certain to meet upon receiving a declaration of unavailability from any of the selected users.

13. A non-transitory computer-readable storage medium encoded with data and instructions that, when executed by a computing system, cause the computing system to:
identify a plurality of invitees in response to an event scheduling request;
obtain scheduling information each invitee, wherein the scheduling information includes information obtained from at least two different types of calendaring system, and wherein the scheduling information includes other events associated with each invitee;
assign a priority for each invitee based on the scheduling information and the event scheduling request, wherein assigning priorities includes determining the level of necessity of attendance by each invitee; and
select a prospective event date based on the assigned priorities and the event scheduling request.

14. The storage medium of claim 13, wherein at least two of the invitees uses a calendaring system in different domains.

15. The storage medium of claim 13, wherein the data and instructions, when executed by a computing system, cause the computing system to identify a resource to used in connection with the event that is the subject of the event scheduling request the requested a plurality of invitees in response to an event scheduling request, wherein selecting a prospective event date includes determining availability of the resource.

16. The storage medium of claim 15, wherein the resource comprises a teleconferencing system.

17. The storage medium of claim 15, wherein the resource comprises support personnel.

18. The storage medium of claim 13, wherein the scheduling information is obtained by a universal scheduler configured to interact with a plurality of different calendaring systems.

19. The storage medium of claim 18, wherein the plurality of different calendaring systems comprises an enterprise calendaring system.

20. The storage medium of claim 18, wherein the plurality of different calendaring systems comprises an Internet-based appointment system.
